(19) United States
(12) Patent Application Publication
(10) Pub. No.: US 2013/0101482 A1
(43) Pub. Date: Apr. 25, 2013

(54) SYSTEMS AND DEVICES FOR RESTRAINING A MICRO-OBJECT AND ASSOCIATED METHODS

(71) Applicant: NANOINJECTION TECHNOLOGIES, L.L.C., Salt Lake City, UT (US)

(72) Inventor: Quentin T. Aten, Orem, UT (US)

(73) Assignee: NANOINJECTION TECHNOLOGIES, L.L.C., Salt Lake City, UT (US)

(21) Appl. No.: 13/656,523

(22) Filed: Oct. 19, 2012

Related U.S. Application Data
(60) Provisional application No. 61/550,181, filed on Oct. 21, 2011.

(51) Int. Cl. B01L 9/00; B23P 11/00

(52) U.S. Cl. 422/560; 29/428

(57) ABSTRACT

Systems, devices, and methods for restraining a micro-object are provided. In one aspect, a micro-object restraint device is provided having a micro-barrier structure coupled to a support substrate, where the micro-barrier structure has two micro-object holding regions. Each micro-object holding region includes a micro-object receiving opening defined in the micro-barrier structure, a micro-object impeding opening at an internal region of the micro-barrier structure, and at least two contact points positioned adjacent to the micro-object impeding opening and oriented to contact and impede a micro-object at the micro-object opening. The two micro-object holding regions abut one another and the micro-object openings from the two micro-object holding regions are continuous.

### PRIORITY DATA

This application claims the benefit of U.S. Provisional Patent Application Ser. No. 61/550,181, filed on Oct. 21, 2011, which is incorporated herein by reference.

### BACKGROUND OF THE INVENTION

Microinjection of foreign materials into a biological structure such as a living cell can be problematic. Various transfection techniques include the microinjection of foreign genetic material such as DNA into the nucleus of a cell to facilitate the expression of foreign DNA. For example, when a fertilized oocyte (egg) is transfected, cells arising from that oocyte will carry the foreign genetic material. Thus in one application, organisms can be produced that exhibit additional, enhanced, or repressed genetic traits. In some cases, researchers have used microinjections to create strains of mice that carry a foreign genetic construct causing macrophages to auto-fluoresce and undergo cell death when exposed to a certain drugs. Such transgenic mice have since played roles in investigations of macrophage activity during immune responses and macrophage activity during tumor growth.

Prior art devices for restraining a cell or an embryo during micromanipulation generally consist of hollow capillary tubes with polished ends. In some cases suction is applied to the capillary to secure the embryo on the end of the capillary. In other cases, the embryo can be rotated by alternately applying suction and pressure while moving the capillary to expel and secure the embryo, now in a rotated orientation, at the tip of the capillary. Researchers have produced various mobile embryo restraints employing movable tweezer-like structures, or graspers with moveable finger-like elements. These mobile restraints have not found wide use in the manipulation of embryos.

### Definitions of Terms

In describing and claiming the present invention, the following terminology will be used in accordance with the definitions set forth below.

The singular forms “a,” “an,” and, “the” can include plural referents unless the context clearly dictates otherwise. Thus, for example, reference to “a cell” can include reference to one or more of such cells, and reference to “an oocyte” can include reference to one or more of such oocytes.

As used herein, the term “micro-object” is used to describe objects of a size on a micro scale. One exemplary range for the term “micro-object” can be an object having an approximate diameter of from about 1 μm to about 1000 μm. Another range can be from about 10 μm to about 250 μm. It should be noted that the present scope contemplated object sizes of less than 1 μm, and that the present techniques can be utilized to restrain objects of any size capable of manipulation. The term “micro-object” can be used to describe both biological and non-biological material.

As used herein, the term “cellular injector” refers to any structure or device that can be utilized to introduce biological material into a cell. Non-limiting examples of cellular injectors can include micropipettes, lances, and the like. As such, “injection” as used herein can include any technique for introducing a biological material into a cell that involves a cellular injector. It is also contemplated that a cellular injector can be used to inject a biological material into a micro-object that may not necessarily be a cell.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free” of particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint without affecting the desired result.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

### BRIEF DESCRIPTION OF THE DRAWINGS

FIG. 1 is a graphical representation of a micro-restraining device in accordance with one embodiment of the present disclosure.

FIG. 2 is a graphical representation of a cell in a micro-restraining device in accordance with another embodiment of the present disclosure.

FIG. 3 is a graphical representation of a micro-restraining device in accordance with another embodiment of the present disclosure.

FIG. 4 is a graphical representation of a support substrate insert device in accordance with another embodiment of the present disclosure.

FIG. 5a is a graphical representation of a support substrate insert and a slide support device in accordance with another embodiment of the present disclosure.

FIG. 5b is a graphical representation of a support substrate insert and a slide support device in accordance with another embodiment of the present disclosure.

FIG. 6a is a graphical representation of the top side of a slide support device in accordance with another embodiment of the present disclosure.

FIG. 6b is a graphical representation of the bottom view of a slide support device in accordance with another embodiment of the present disclosure.

FIG. 7a is a graphical representation of a support substrate insert and a slide support device in accordance with another embodiment of the present disclosure.

FIG. 7b is a graphical representation of a support substrate insert and a slide support device in accordance with another embodiment of the present disclosure.

FIG. 7c is a graphical representation of a support substrate insert and a slide support device in accordance with another embodiment of the present disclosure.

### DETAILED DESCRIPTION

The present disclosure provides methods, devices, and associated systems for restraining very small objects, such as for example, objects that are micro-sized. In some aspects, such micro-objects can include biological objects such as individual cells, collections of cells, embryos, tissue, and the like. For example, in one aspect a cell can be restrained during the delivery of a biological material into the cell. It should be noted that, while the present disclosure refers often to cellular restraint, the present system is not limited to use with micro-objects of a biological origin. For example, micro-beads and other micron-sized objects can also be restrained in a similar manner.

Current techniques of merely holding a cell with a suction pipette during delivery of biological material to or into the cell can be problematic for a number of reasons, such as: microscopic limitations in a three dimensional environment, issues with alignment of the cellular injector with the cell, movement of the cell during delivery, deformation of the cell during withdrawal of the cellular injector, and the like. Additionally, traditional injection procedures are highly technical and time consuming, and often injection technicians need extensive training to become proficient. The often difficult techniques of such delivery procedures can be simplified by adequately restraining the cell in a known position. It should be noted, however, that the present restraint techniques and structures can be utilized to restrain a cell for numerous reasons. As such, any reasoning or justification for cellular or other micro-object restraint is considered to be within the present scope.

The present disclosure provides devices and methods for restraining a micro-object in a manner that avoids many if not all of the above described limitations. In one aspect, a micro-object restraint device is provided having a micro-barrier structure coupled to a support substrate, where the micro-barrier structure has at least two micro-object holding regions. Each micro-object holding region includes a micro-object receiving opening defined in the micro-barrier structure, a micro-object impeding opening defined in an internal region of the micro-barrier structure, and at least one contact point positioned adjacent the micro-object impeding opening and oriented to contact and impede a micro-object at the micro-object opening. The two micro-object holding regions abut one another and the micro-object openings from the two micro-object holding regions are continuous. In one aspect, the micro-object restraint device can include a microscope. In another aspect, the microscope can include an inverted microscope, however traditional top-view microscopes are additionally contemplated.

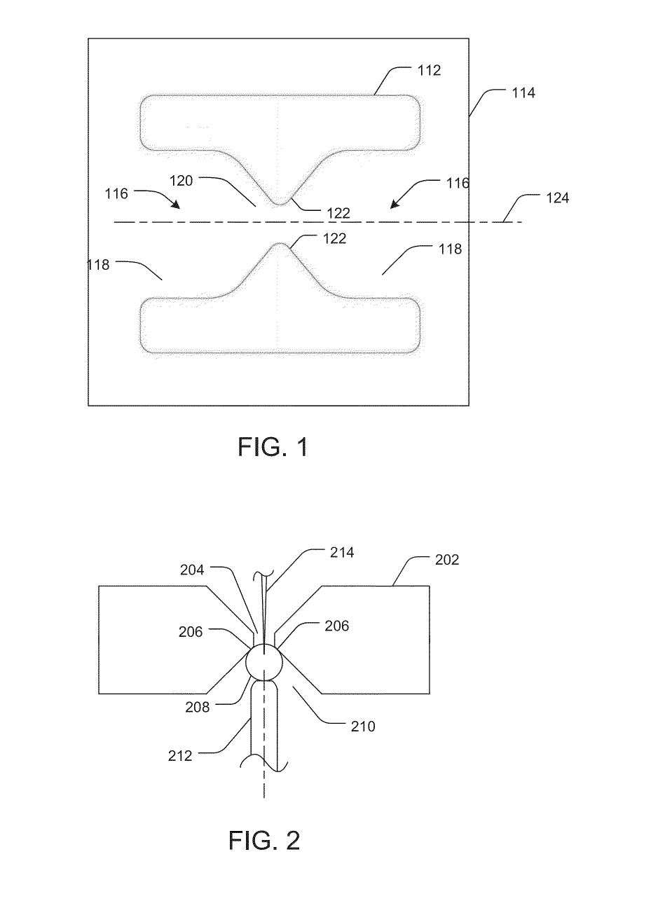

In one aspect, as is shown in FIG. 1, a micro-barrier 112 can be coupled to a support substrate 114. The micro-barrier 112 can include any number of micro-object holding regions 116; however FIG. 1 exemplifies two that are positioned opposite one another. Each micro-object holding region 116 can include a micro-object receiving opening 118 and a micro-object impeding opening 120. Each micro-object impeding opening 120 can have at least one micro-object contact point 122 to contact and impede a micro-object at the micro-object opening 120. In some cases, the micro-object impeding opening can have at least two micro-object contact points 122. In the design shown in FIG. 1, the contact points 122 can vary in location depending on the size and the shape of the micro-object. Additionally, although other configurations are contemplated, FIG. 1 shows one of the micro-object holding regions 116 oriented 180° relative to the other micro-object holding region 116 along a manipulation axis 124 oriented through the micro-barrier structure 112. Such an orientation allows a micro-object to be held in either side of the restraint and manipulated from the opposite side.

In another specific aspect, a micro-barrier structure can include four micro-object holding regions oriented at 90° intervals from one another, as opposed to the 180° orientation shown in FIG. 1. Such a configuration can be useful for many reasons, one of which includes situations where it may be beneficial to access a micro-object such as a cell from more than two directions. Similarly, a micro-barrier structure can include three micro-object holding regions oriented at 120° intervals from one another. Thus, the design of the micro-barrier structure and the micro-object holding regions can vary depending on the intended use of the structure and desired manipulation of a micro-object.

As has been described, one use for the present technology is as a restraining device for restraining cells during delivery or injection of a biological material therein. One example of such a restraint is shown in FIG. 2. In this case, a micro-barrier 202 is shown having a micro-object impeding opening 204 and at least two contact points 206. A cell 208 is shown in a micro-object holding region 210 against the contact points 206. As such, the cell 208 is held by the contact points 206 because the impeding opening 204 is too small to allow the cell 208 to pass therethrough. The cell 208 can be held against the contact points 206 by pressing with a micro-object manipulator 212. By pressing the cell against the contact points, the cell can be immobilized for the injection procedure. Once the cell 208 is in position against the contact points 206, a cellular injector 214 (i.e. a micro-object injector) can be inserted through the opening 204 and into the cell 208. A biological material can be associated with the cellular injector that can subsequently be delivered into the cell. Pressure applied by the micro-object manipulator 212 thus maintains the position of the cell 208 relative to the opening 204 during the procedure.

Following injection, the cellular injector 214 is withdrawn from the cell 208. In many traditional techniques the cell can be deformed and possibly damaged during withdrawal of a delivery apparatus. Cellular membrane and other cellular components can become associated with the delivery apparatus, thus pulling away from the center of the cell during withdrawal. This pulling of the cellular membrane and internal cellular structures is increased by the traditional use of a suction pipette to hold the cell. In essence, the cell is being distorted by opposing point forces at opposite sides of the cell pulling in opposite directions. Such a distortion can cause cellular damage that can negatively affect the outcome of an injection procedure. In the present example, however, the position of the cell 208 against the contact points 206 allows the cellular injector 214 to be withdrawn with reduced cellular deformation. As the cellular injector 214 is withdrawn, the force applied by the contact points 206 against the cell 208 can overcome the adherence forces between the cellular membrane and the cellular injector, thereby reducing cellular deformation. Such a cell manipulating structure can thus restrain the cell during cellular injection. Such restraint can greatly simplify the injection procedure, decreasing the time required to perform an injection and reducing many of the technical barriers associated with such procedures.

Various micro-object manipulator devices are contemplated, and any device capable of delivering and/or holding the micro-object in position at the micro-object impeding opening is considered to be within the present scope. In one aspect, for example, the micro-object manipulator can be a suction pipette. In another aspect, the micro-object manipulator can be a glass or polymeric rod. Additionally, multiple micro-object manipulators can be used. The micro-object manipulator(s) can be located and oriented in any position capable of maintaining the position of the micro-object during a manipulation procedure.

Additionally, a variety of cellular injector configurations are contemplated, and any such configuration is considered to be within the present scope. In one aspect, for example, the cellular injector can be a traditional or nontraditional micropipette. Micropipettes can be made from a variety of materials, including various types of glass (e.g. borosilicate, aluminosilicate, etc.), quartz, polymers, ceramics, and the like. In the case of a glass micropipette, for example, the ends of a glass capillary tube can be pulled in opposite directions following the heating of a center region in order to create a micropipette having a sharp tip and a hollow interior. A micropipette can be filled with a solution containing a biological material to be injected into a cell. In another aspect, the micropipette can be filed with a solution containing one or more cells to be injected into a cell or embryo. The micropipette is often coupled to a movement system such as a micromanipulator to allow precise movements of the tip of the micropipette. Thus, the micropipette is inserted into a cell, and the biological material is then expelled from the interior of the micropipette and into the cell. Although any technique for expelling the biological material is contemplated, in some aspects a micropump can be used. In other aspects, an electrical charge can be used to expel the biological material. Following delivery of the biological material, the micropipette can then be withdrawn from the cell.

In another aspect, the cellular injector can be a lance. A lance is a solid or semisolid structure, and in some cases can have an internal channel. It is contemplated that a lance can be an integral part of a lance manipulation system, or the lance can be fabricated and utilized in traditional manipulation systems such as micromanipulators and the like. As such, in some aspects the lance is manufactured as a “stand alone” lance, and is not constrained to a fixed substrate upon which the lance was fabricated. Any size and/or shape of lance capable of delivering biological material into a cell is considered to be within the present scope.

Biological material can be delivered using the present system into a variety of cells. Both prokaryotic and eukaryotic cells are contemplated that can receive biological material, including cells derived from, without limitation, mammals, plants, insects, fish, birds, yeast, fungus, and the like. Additionally, cells can include somatic cells or germ line cells such as, for example, oocytes and zygotes. In one aspect, the cell can be an embryonic stem cell or a plurality of embryonic stem cells.

Additionally, various types of biological materials are contemplated for delivery into a cell, and any type of biological material that can be delivered into a cell can be utilized in conjunction with the present restraint devices. Non-limiting examples of such biological materials can include DNA, cDNA, RNA, siRNA, tRNA, mRNA, microRNA, peptides, synthetic compounds, polymers, dyes, chemical compounds, organic molecules, inorganic molecules, hormones, and the like, including combinations thereof. In one aspect, the biological material can include DNA, cDNA, RNA, siRNA, tRNA, mRNA, microRNA, and combinations thereof. In another aspect, the biological material can include DNA and/or cDNA. Additionally, in some aspects biological material can also include one or more cells. Non-limiting examples can include embryonic stem cells, sperm, and the like.

Further exemplary details regarding cellular injectors, charging systems, movement systems, and restraining systems can be found in U.S. patent application Ser. Nos. 12/668,369, filed Sep. 2, 2010; Ser. No. 12/816,183; filed Jun. 15, 2010; 61/380,612, filed Sep. 7, 2010; and 61/479,777, filed on Apr. 27, 2011, each of which is incorporated herein by reference.

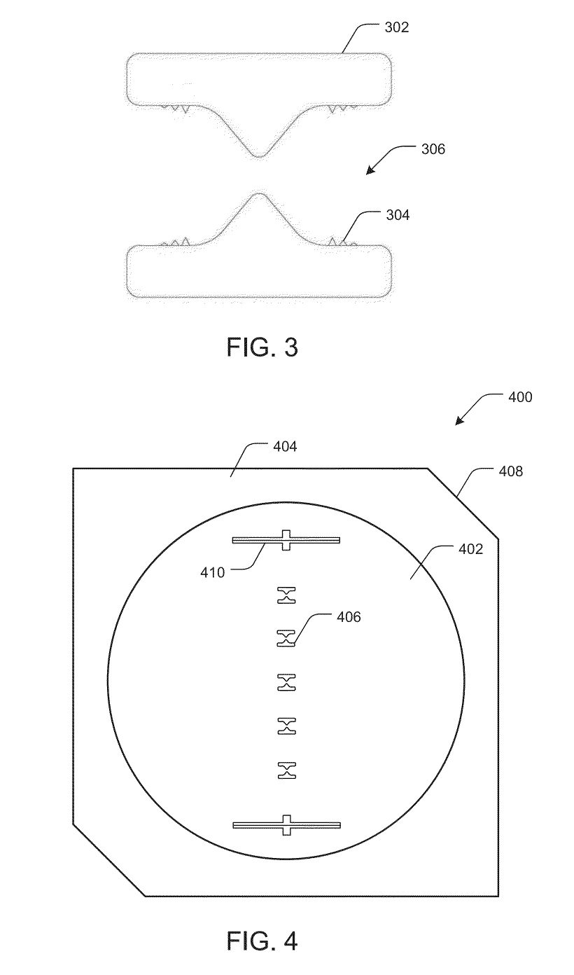

Returning to cellular manipulation and restraint, one of the technical difficulties associated with cellular injection involves the reorienting of a cell into a desired orientation. This is a particularly useful manipulation in situations where an injection will be targeting a specific organelle or location within the cell. In many cases, experienced injection technicians can release and reapply suction from a holding pipette in a manner that allows a cell to roll over in the fluid media, thus facilitating reorientation. Such a technique, however, can be difficult to master, and can increase the time required for each injection. In one aspect of the present disclosure, the cell can be reoriented by rolling or otherwise manipulating the cell against an inside surface of the micro-barrier. Such a reorienting can be done quickly and with very little training. Thus, in some aspects the micro-object holding region can include at least one reorienting structure positioned to facilitate reorienting of the micro-object within the micro-object holding region. In one specific aspect, the reorienting structure can include material deposited on the micro-barrier structure within the micro-object holding region. The deposited material can be the same material used to construct the micro-barrier or it can be a material that is different from that used to construct the micro-barrier. In another specific aspect, the reorienting structure can include a perturbed or distressed region of the micro-barrier structure within the micro-object holding region. For example, the perturbed region can be roughened or otherwise affected to facilitate reorientation of the cell at that surface. FIG. 3 shows one example of a micro-barrier 302 having reorienting structures 304 located within the micro-object holding region 306.

The micro-barrier can be made of a variety of materials and can have a variety of structural configurations. Any such material or configuration that allows restraint of a micro-object is considered to be within the present scope. Non-limiting examples of materials that can be used include semiconductors, ceramics, carbon nanotubes, glass, polymeric materials, metals, and other suitable materials, including combinations thereof. In one specific aspect, the micro-barrier material can be a polymer. In another aspect, the micro-barrier can be a polymer such as a cyclic olefin polymer or copolymer. Additionally, the micro-barrier can be an extension of the material of the underlying substrate or it can be a separate material. A separate material can be formed on the underlying substrate, or it can be formed apart from the substrate and later associated therewith.

In some cases, the material used to form the micro-barrier and/or at least a portion of the support substrate can be one that minimizes optical distortions. For example, the restraint devices of the present disclosure can be utilized with inverted microscopes whereby light is directed from beneath the micro-barrier to the microscope optics located above the micro-barrier. Minimizing optical distortions allows light to more readily pass from the light source of the microscope to the associated optics. Various low optical distortion materials are well known in the art. It should be noted, however, that the micro-barrier and/or support substrate material can have varying levels of transparency, and in some cases can be opaque or non-transparent. Such would be the case, for example, for microscopes that do not require light transparent substrates, such as a microscope viewing the preparation from above.

The physical configuration of the restraining device can vary depending on the specifics of the cell being restrained, the equipment being used, and/or the preferences of the user. In some cases, for example, the physical configuration of the micro-barrier can be designed to correspond to a particular type of cell or micro-object being restrained. For example, the micro-object receiving opening and the micro-object impeding opening can vary depending on the size of the micro-object being restrained and the size of the injector or manipulator that will pass therethrough. While the micro-object receiving opening should be large enough to allow a micro-object to pass into the micro-object holding region, the micro-object impeding opening should be small enough to preclude the micro-object from passing therethrough or becoming lodged therein.

Thus the size of the micro-object impeding opening can thus vary depending on a variety of factors, and as such, should not be seen as limiting. In one aspect, however, the micro-object impeding opening can be from about 25 microns to about 75 microns wide. In another aspect, the micro-object impeding opening can be from about 50 microns to about 70 microns wide. In yet another aspect, the micro-object impeding opening can be from about 60 microns to about 80 microns wide. In one specific aspect, the micro-object impeding opening can be from about 2 microns to about 25 microns wide. Additionally, the micro-object impeding opening can be of any physical configuration, such as circular, elliptical, polygonal, etc. Furthermore, in some aspects the micro-object impeding opening can be a slot in the micro-barrier. For such cases, the sizes recited above would be width measurements. In one specific aspect, the micro-object impeding opening can be configured to receive and/or allow the passage of a cellular injector therethrough.

Additionally, the micro-barrier can be of any height sufficient to restrain a micro-object. Thus the height of the micro-barrier from the support substrate can vary depending on the size and shape of the micro-object being restrained. For example, a useful height may be about 100 microns. Such a structure may adequately restrain micro-objects having a size less than about 150 or 100 microns. In many cases, a micro-barrier can restrain cells that have a midline that is less than the height of the cell manipulating structure.

Any technique capable of forming a micro-barrier structure on a support substrate is considered to be within the present scope. Forming the micro-barrier on the support substrate can include depositing material onto a substrate as well as forming the micro-barrier as part of the substrate. For purposes of economy it can be useful to form the micro-barrier simultaneously with the support substrate in a patterned mold, although any useful manufacturing technique can be used. Non-limiting examples include MEMS, micro embossing, microinjection molding, photosensitive processes, 3D printing, machining, and the like. It is also contemplated that the choice of a particular technique for forming the restraint device can be related to the size of the micro-barrier and the other features with respect to the costs associated with particular technologies.

In some aspects, multiple micro-barrier structures can be coupled to a single support substrate. The micro-barrier structures can be of the same size and shape or they can be of different sizes and/or shapes. Additionally, one or more micro-barriers can be coupled to a support substrate insert that is further coupled to a more substantial support, such as a support slide. The support substrate insert can be coupled to the more substantial support, or the support substrate insert can merely rest upon the more substantial support. A support slide can be any support that is roughly the same size and shape as a microscope slide so as to interface with current microscopes. Supports having other configurations and shape would of course also be included in the present scope.

One example of a substrate support insert 400 is shown in FIG. 4. In this aspect, a liquid well 402 is formed in a substrate support insert 404. Such a liquid well 402 can retain fluid in a localized region, thus reducing the waste of biological media and other biological material. A plurality of micro-barriers 406 can be formed on the support substrate insert 404 within the liquid well 402. The plurality of micro-barriers can have a common configuration, or they can differ in size, shape or componentry, depending on the desired usage of the device. In one aspect, alignment cutouts 408 or other alignment structures can be formed in or on the substrate support insert 404 to allow proper alignment of the insert with the more substantial support (e.g. a support slide). Furthermore, alignment features 410 can be associated with the substrate support insert 404 and aligned with the micro-barriers 406 in order to allow a user to more readily align the micro-barrier with such tools as cellular injectors and micro-object manipulators. For example, once the support substrate insert has been positioned in a more substantial support, such as a support slide, the micro-barriers can be aligned by orienting the alignment features relative to a microscope stage. It should be noted that, while microscope slide-type support substrates have been described, other designs are contemplated and are considered to be within the present scope. For example, the micro-restraint devices of the present disclosure can be incorporated into Petri dishes, well plates, and the like.

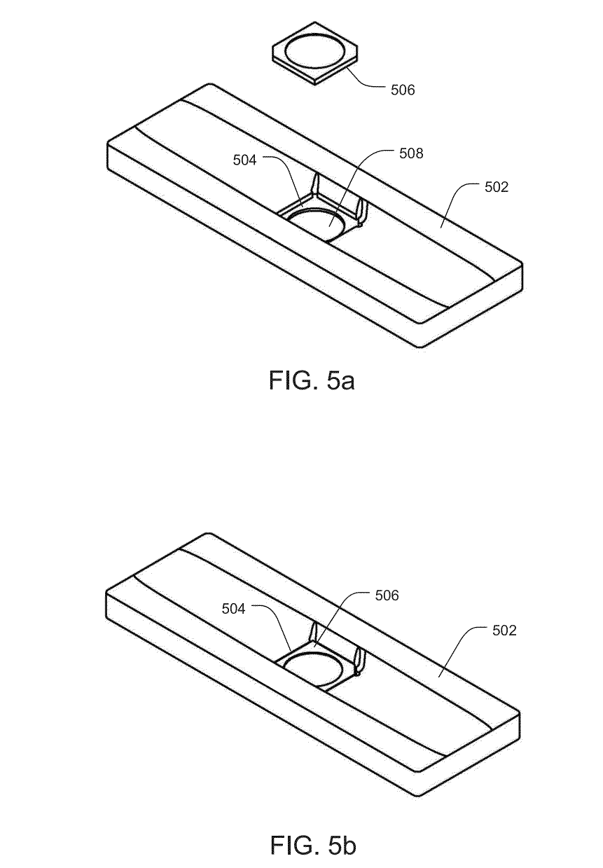

Various support slide configurations are contemplated, and any structure capable of receiving the support substrate insert is considered to be within the present scope. In one exemplary aspect, shown in FIG. 5a, a slide support 502 can have a size and shape that is compatible with a microscope stage. The slide support 502 can include a receiving region 504 that can be configured to receive a support substrate insert 506. The receiving region 504 can include an optical pathway 508 therethrough, or the receiving region can lack such an optical pathway (not shown). An optical pathway 508 can allow light to pass through the support substrate insert 506 from one side of the slide support 502 to the other, for example, from a light source to microscope optical system. FIG. 5b shows the support substrate insert 506 in the receiving region 504 of the slide support 502.

The support substrate insert can be placed into and held by the receiving region of the slide support according to a variety of techniques, all of which are considered to be within the present scope. For example, in one aspect the receiving region can be shaped or have features that correspond to features on the support substrate insert such that the insert can be snapped into place. Thus, the support substrate insert is held in place at least in part by the features. In this case, the support substrate can be place on the receiving region and pressed into place. This can be accomplished with a dedicated tool, forceps, fingers, or any other technique or tool capable of engaging the insert in the receiving region without damaging the micro-barrier structures. In another aspect, the support substrate insert can be placed into the receiving region and held therein with an adhesive or tacky material. Such can include, without limitation, polymeric adhesives, polymeric tacky materials, glues, waxes, rubber compounds, gels, and other materials that facilitate some level of adhesion. In some aspects, the support substrate insert can be merely placed into the receiving region and held in place by the mass of the support substrate insert. It is contemplated that in one aspect the support substrate insert can be permanently fixed in the receiving region. In another aspect the support substrate insert can be removably fixed in the receiving region.

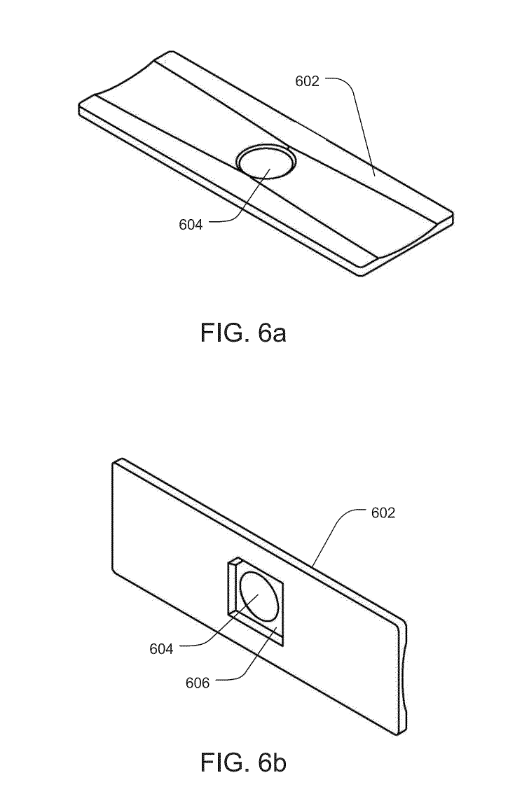

FIGS. 6a-b show aspect whereby a slide support 602 includes an optical pathway 604 and a recessed region 606 located on the bottom surface of the slide support 602. FIG. 6a shows a view of the top side of the slide support 602, while FIG. 6b shows a view of the bottom side of the same slide support 602. Thus the micro-barrier structure or structures on the support substrate insert (not shown) are exposed through the optical pathway once positioned in the receiving region 606. In other aspects, it is also contemplated that the recessed region can be formed in a top surface of the slide support where the support substrate insert can be dropped into place.

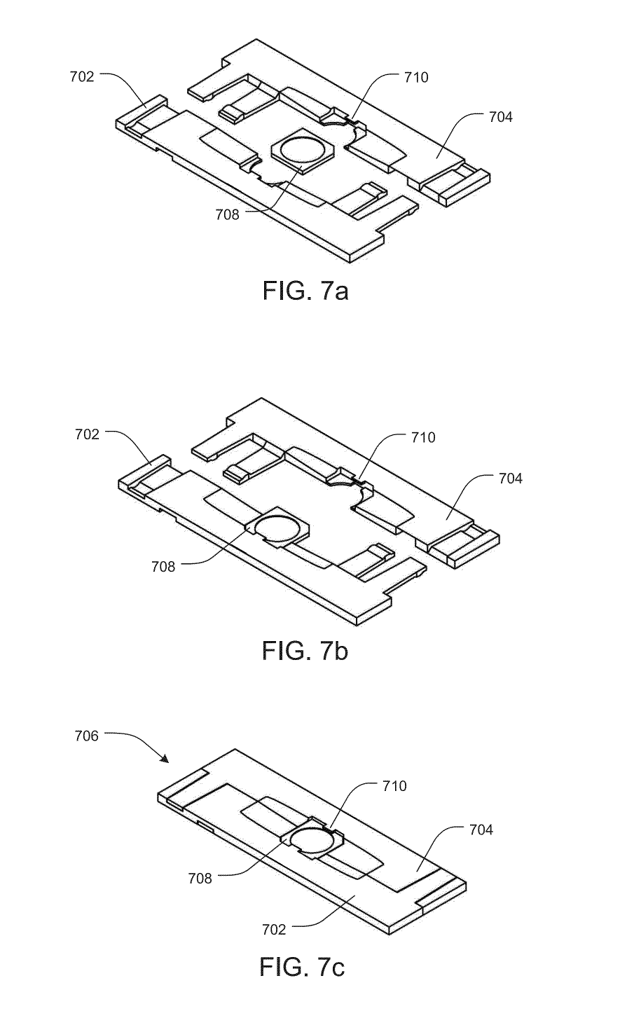

In another aspect, as is shown in FIGS. 7a-c, the slide support can be formed from multiple parts. While one particular design is shown and described, it is to be understood that this is merely exemplary, and that other designs having multiple parts are also within the present scope. In the case of FIGS. 7a-c, a first slide support portion 702 and a second slide support portion 704 can be engaged together to form a complete slide support 706. In one aspect, the support substrate insert 708 can be placed into either the first or second slide support portion 702, 704 prior to engaging the two portions with the complete slide support 706. One or more of the first and second slide support portions can include at least one feature 710 to secure the slide support insert 708 in place once the portions are engaged. Additionally, in one aspect the first and second slide support portions are designed and intended to remain engaged for the lifetime of the slide support. In another aspect, the first and second slide support portions are designed and intended to be removably engaged with one another, thus allowing replacement of the support substrate insert.

It is to be understood that the above-described compositions and modes of application are only illustrative of preferred embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed:

1. A micro-object restraint device, comprising:
a micro-barrier structure coupled to a support substrate, the micro-barrier structure having two micro-object holding regions, each micro-object holding region including:
a micro-object receiving opening defined in the micro-barrier structure;
a micro-object impeding opening defined in an internal region of the micro-barrier structure; and
at least one contact point positioned adjacent to the micro-object impeding opening and oriented to contact and impede a micro-object at the micro-object opening;
wherein the two micro-object holding regions abut one another and the micro-object openings from the two micro-object holding regions form a substantially continuous opening.

2. The device of claim 1, wherein one of the micro-object holding regions is oriented 180° relative to the other micro-object holding region along a manipulation axis defined through the micro-barrier structure.

3. The device of claim 1, wherein the micro-object includes a member selected from the group consisting of a cell, an embryo, a biological tissue, a polymeric bead, and combinations thereof.

4. The device of claim 1, further comprising a micro-object manipulator, at least a portion of which is sized and shaped to press the micro-object against the contact points.

5. The device of claim 4, further comprising a micro-object injector, at least a portion of which is sized and shaped to be inserted through the micro-object opening and into the micro-object, wherein the micro-object manipulator is operable to maintain the micro-object against the at least one contact point as the micro-object injector is inserted into the micro-object.

6. The device of claim 4, wherein the micro-object manipulator is positionable to apply a force that is approximately opposite in direction relative to an insertion direction of the micro-object injector through the micro-object opening.

7. The device of claim 1, wherein each micro-object holding region further includes at least one reorienting structure positioned to facilitate reorienting of the micro-object within the micro-object holding region.

8. The device of claim 7, wherein the reorienting structure includes a material deposited on the micro-barrier structure within the micro-object holding region.

9. The device of claim 7, wherein the reorienting structure includes a perturbed region of the micro-barrier structure within the micro-object holding region.

10. The device of claim 1, further comprising multiple micro-barrier structures coupled to the support substrate.

11. The device of claim 1, further comprising a support slide having a support substrate receiving region, wherein the support substrate is coupled to the support substrate receiving region.

12. The device of claim 1, wherein the support substrate includes at least one visual alignment feature to facilitate relative alignment of the micro-barrier structure.

13. The device of claim 1, wherein the micro-barrier structure includes a material selected from the group consisting of semiconductors, ceramics, carbon nanotubes, glass, polymeric materials, metals, and combinations thereof.

14. The device of claim 1, wherein the micro-barrier structure is formed of a polymeric material.

15. The device of claim 1, wherein the polymeric material is a cyclic olefin polymer or a cyclic olefin copolymer.

16. A method of restraining a micro-object device, comprising utilizing the structure of claim 1.
